(19) United States
(12) Patent Application Publication
(10) Pub. No.: US 2015/0282516 A1
(43) Pub. Date: Oct. 8, 2015

(54) METHOD FOR INCREASING FOOD SAFETY BY MEANS OF A HIGH-PRESSURE TREATMENT OF RAW MATERIALS OR SEMIFINISHED PRODUCTS

(71) Applicants: DIL Deutsche Institut fur Lebensmitteltechnik e.V., Quakenbrück (DE); Triton GmbH, Berlin (DE)

(72) Inventors: Volker Heinz, Quakenbrück (DE); Fritz Kortschack, Berlin (DE)

(21) Appl. No.: 14/434,889

(22) PCT Filed: Sep. 11, 2013
(86) PCT No.: PCT/EP2013/068802

§ 371 Date: Apr. 10, 2015

(30) Foreign Application Priority Data
Oct. 12, 2012 (DE) 102012020416.7
Nov. 15, 2012 (DE) 102012022459.1
Apr. 16, 2013 (DE) 102013006579.8

(51) Int. Cl. A23L 3/015; A23L 1/01; A23L 1/305; A23L 3/358; A23L 3/3571

(52) U.S. Cl. CPC A23L 3/0155; A23L 3/358; A23L 3/3571; A23L 1/3055; A23L 1/01; A23V 2002/00

(57) ABSTRACT

The invention relates to a method for increasing food safety by means of a high-pressure treatment of raw materials or semi-finished products. A high-pressure treatment of the product is carried out during the production of the product while monitoring a product-specific dwell time in order to reduce the microbial count in a controlled manner without using heating processes. The products are then packed, stored, and transported to the consumer, where the product is thermally heated so as to be safe for human consumption, in particular with respect to the desired cut resistance.

### CROSS REFERENCE TO RELATED APPLICATIONS

This application is a national phase of PCT Application Number PCT/EP2013/068802 filed Sep. 9, 2013 which claims priority to German patent applications DE102012020416.7 filed Oct. 12, 2012, DE102012022459.1 filed Nov. 15, 2012, and DE102013006579.8 filed Apr. 16, 2013, the entire contents of which are hereby incorporated by reference herein.

### BACKGROUND

The high-pressure treatment of foodstuffs is a method for preserving and modifying same. In these methods, foods are typically subjected to hydrostatic pressures of more than 150 MPa for some seconds up to several minutes. A high-pressure method of this type allows microorganisms to be killed at low temperatures and enzymes to be inactivated, while low-molecular compounds adding value to the foodstuffs, e.g. vitamins, coloring and flavoring agents, remain largely unaffected and preserved.

It is disclosed in DE 10 2008 048 543 B4 and DE 10 2010 010 118 A1 that the food safety can be improved by a high-pressure treatment. The product properties of the finished products can be controlled during the production process by the time, the pressure intensity, the duration and the frequency of the high-pressure treatment.

An alternative for the shelf life extension of foodstuffs is the classical heat treatment. However, it these heat-treated products are heated for final consumption purposes, it is often the case that the desired crispness gets lost, the products are tasteless and shapeless.

### SUMMARY

The invention relates to a method for increasing food safety by means of a high-pressure treatment of raw materials or semi-finished products.

Based on the foregoing, it is an object of the invention to provide an improved method for increasing the food safety by means of a high-pressure treatment of raw materials or semi-finished products, ensuring, on the one hand, that a significant overall germ reduction is achieved, and thus extending the shelf life of the products or semi-finished products, especially if these products are cooled. In addition, the possibility is to be provided that the corresponding products can be subjected to a thermal treatment, i.e. heated, by the end consumer so as to be eatable, without affecting the flavor, and without negative impacts on the consistency of the product.

Accordingly, there is proposed a method for increasing the food safety by means of a high-pressure treatment of raw materials or semi-finished products, wherein the high-pressure treatment of the product is carried out taking into account a product-specific retention time for the directed germ reduction, without separate or additional heating processes during the production of the product.

Subsequently, the products are packaged and stored as usual, and are delivered to the consumer, taking into account possibly required cold chains. Finally, the product is heated in a consumption-appropriate manner, which leads to a solidification of the mixture and a desired cuttability.

In one embodiment, the high-pressure treatment is carried out in pressure ranges between 3000 bar and >6000 bar, preferably 4000 bar to 6000 bar, with retention times between 2 and 5 minutes, preferably substantially 3 minutes.

In one embodiment, antimicrobial substances may be added prior to the high-pressure treatment, such as nitrite curing salt or the like.

Also, it is possible to supply CO₂ to the product, or subject the product to CO₂, prior to the high-pressure treatment.

Alternatively, or additionally, it is possible to supply bacteriophages to the raw materials to be treated prior to the actual high-pressure treatment. These bacteriophages serve to inactivate possibly existing pathogenic germs. Similarly, bacteriophages may also be added during the preparation of raw materials. In this case, it should at any rate be ensured that the bacteriophages useful for this purpose will not inactivate existing, respectively, applied protective cultures or starter cultures. The bacteriophages applied, which do not present a problem to the human organism, infect problematic bacteria cells with their genotype. The host cell is then caused to produce phages, and the pathogenic germ virtually destroys itself. For example, the use of viruses in poultry affected by campylobacter can reduce the infestation by more than 90%. This similarly applies to dangerous salmonellae and E. coli.

If it is desired to replace animal protein by vegetable protein, partially or completely, the vegetable protein is may be subjected to a separate high-pressure treatment for the purpose of a germ reduction, whereby the vegetable proteins, which are usually available in a ground and dry form, are soaked, i.e. hydrated, prior to the high-pressure treatment.

The thermal treatment of a raw material, which is carried out subsequent to a previous high-pressure application of the raw material for the germ reduction thereof, whose protein was denaturated by the pressure treatment, results in an increased solidification of the mixture on account of the later performance of the thermal treatment.

Such a treatment permits the production of products that were quasi “cold-pasteurized” and made durable by a high-pressure treatment and, at a later time after days or weeks, gain firmness, respectively, consistency by a heating process, which improves the quality of the finished product.

In conventional prior art methods, the consistency of foodstuffs denaturated by a thermal treatment decreases with each additional thermal treatment, which presents a considerable drawback for the finished product. For example, sausages, which are tasty and firm as such, may be tasteless and shapeless after having been heated multiple times.

During the cold pasteurization of shaped, yet raw sausage meat by a high-pressure treatment no aromatic substances or flavoring agents are lost. Also, no protein is lost. The required consumption-relevant heating permits the consumer to experience a virtually “pot-fresh” product.

Scalded sausages, meatloaf and similar products are particularly well-suited for the treatment according to the invention.

It can be learned from the table inserted below that a significant total germ reduction can be realized by the high-pressure treatment (HPP) of raw sausage meat, thereby allowing an extension of the shelf life of the cooled semi-finished product by several weeks.

It can also be learned from the measured data according to the table shown below that a thermal treatment has to be carried out after the high-pressure treatment to obtain the desired consistency, respectively, cuttability. However this final heating of the germ-reduced starting material may be performed time-shifted by the consumer, so that the heating process during the production is not required and energy can be saved in the production process.

A varied choice of the pressure range, retention time and subsequent heating period, respectively, reaching the core temperature allows production plants to influence or adjust the product properties of the finished products corresponding to the respective requirements.

| | Aerobic total | Cuttability; |
|---|---|---|
| Product | bacterial count | force [N] |
| scalded sausage, untreated, raw | 1.2 × 10⁷ | measurement |
| | | impossible |
| scalded sausage HPP 4000 bar; | 5.7 × 10³ | 1.48 |
| 3 min. retention time | | |
| scalded sausage HPP 5000 bar; | 1.5 × 10³ | 1.62 |
| 3 min. retention time | | |
| scalded sausage HPP 6000 bar; | 3.3 × 10³ | 1.89 |
| 3 min. retention time | | |
| scalded sausage HPP 4000 bar + | 1.9 × 10² | 4.27 |
| cooked; 68° C. core | | |
| scalded sausage HPP 5000 bar + | 30 | 3.98 |
| cooked; 68° C. core | | |
| scalded sausage HPP 6000 bar + | 20 | 4.00 |
| cooked; 68° C. core | | |

After such a treatment, the salted raw materials, high-pressure treated for the purpose of preservation, e.g. for the production of raw sausage, still have the properties relevant for the production of raw sausage for the control of biochemical processes.

Such products may be subjected to a thermal treatment after the acidification so as to avoid health damages by the consumption of raw nonperishable products. Although water may still be withdrawn from these products after the thermal treatment, the carried out denaturation of the proteins prevents a maturing process that may be required for the raw nonperishable product.

Raw materials for the production of raw nonperishable products, herein explained by the example of spreadable products matured for a short period, are salted with nitrite curing salt prior to the high-pressure treatment and, after the reddening, are subjected to a high-pressure treatment. By the combination of pressure, reaction time, temperature and antimicrobial substances, e.g. nitrite curing salt or pressure-resistant, bacteriocin-forming starter cultures, pathogenic germs (salmonellae, listeria, EHEC etc.), but also mildew are inactivated. By choosing suitable parameters the pathogenic microorganisms are reduced, while the raw material properties required for the production of cuttable and spreadable raw nonperishable products are maintained, and are not destroyed like in a thermal treatment.

It is also possible to supply CO₂ to the product prior to the high-pressure treatment, or subject the product to CO₂.

The table inserted below shows by way of example three different pressure intensities for the treatment of raw sausage meat, as well as the total bacterial count.

| Product; without the addition | Aerobic total |
|---|---|
| of starter cultures | bacterial count |
| untreated raw sausage meat | 3.3 × 10⁵ |
| raw sausage meat HPP 4000 bar; | 2.4 × 10⁴ |
| 3 min. retention time | |
| raw sausage meat HPP 5000 bar; | 4.4 × 10³ |
| 3 min. retention time | |
| raw sausage meat HPP 6000 bar; | 2.0 × 10² |
| 3 min. retention time | |

The high-pressure treated raw material, to which spices and, in particular, starter cultures (protective cultures) for the pH-value reduction were added, was minced to the desired grain size, then filled into casings and subjected to a maturing procedure (tempering, drying and smoking). Despite the denaturation of protein by the high-pressure influence it was possible to produce raw sausage having the typical product properties.

It is to be noted in this context that active protective, respectively, starter cultures should be added as soon as possible after the removal of the raw material from the waterproof protective envelope used during the high-pressure treatment, to prevent undesirable germs from settling down on the low-germ raw material.

The spreadable smoked sausage produced according to the procedure described above includes all product features that are demanded from a product of this type.

For allowing animal protein to be replaced by vegetable protein during the production of foodstuffs it should be ensured, in particular when using this raw material for the production of raw sausage, that the product used is free from contaminations to prevent germs or mildew from thus penetrating into the raw sausage meat.

Typically, vegetable proteins are available in a ground and dry form, and have to be hydrated before use. If processed in raw sausage meat in a dry state, higher dosages of the vegetable protein would bind moisture to such an extent that the protective, respectively, starter cultures used would be deprived of their basis of existence, and no maturation could take place. As of a dosage of vegetable proteins greater 3% strong changes in the product properties of raw sausage can be expected.

Furthermore, the hydration of dry vegetable proteins is desirable for an effective high-pressure treatment to inactivate germs or mildew. The desired (hydrostatic) high-pressure effect involves a minimum moisture content. If a hot medium is used to moisten the vegetable protein spore formers may be caused to germinate. A prompt subsequent high-pressure treatment ensures that the spores are inactivated permanently.

The combined application consisting of hydration, a possible thermal influence, further modification and high-pressure treatment of the vegetable proteins allows an ideal, safe raw material to be gained also for the production of raw sausage.

1. Method for increasing food safety of a raw material or semi-finished food product, the product having been produced without utilizing heating processes, the method comprising the steps of:
high-pressure treating the product according to a product-specific retention time for directed germ reduction;
packaging and storing the product, and delivering the product to a consumer; and
thermally heating the product as appropriate for consumption, thereby obtaining desired product properties.

2. The method according to claim 1, wherein the high-pressure treating is carried out at pressures between 3000 bar and 6000 bar and the product specific retention time is between 2 and 5 minutes.

3. The method according to claim 1, further comprising adding antimicrobial substances to the product prior to the high-pressure treating.

4. The method according to claim 1, further comprising supplying CO₂ to the product, or subjecting the product to CO₂, prior to the high-pressure treating.

5. The method according to claim 1, further comprising replacing, at least partially, animal protein in the product with vegetable protein, wherein the vegetable protein has been subjected to a separate high-pressure treatment.

6. The method according to claim 5, further comprising hydrating the vegetable protein prior to the high-pressure treating.

7. The method according to claim 1, further comprising adding bacteriophages to the product prior to the high-pressure treating.

8. The method according to claim 1, further comprising adding bacteriophages to the product.

9. The method of claim 1, wherein the desired product properties include cuttability of the product.

10. The method of claim 2, wherein the product specific retention time is 3 minutes.

11. The method according to claim 2, further comprising adding antimicrobial substances to the product prior to the high-pressure treating.

12. The method according to claim 2 further comprising supplying CO₂ to the product, or subjecting the product to CO₂, prior to the high-pressure treating.

13. The method according to claim 2, further comprising replacing, at least partially, animal protein in the product with vegetable protein, wherein the vegetable protein was subjected to a separate high-pressure treatment.

14. The method of claim 3, wherein the antimicrobial substances include nitrate curing salt.

15. The method according to claim 3 further comprising supplying CO₂ to the product, or subjecting the product to CO₂, prior to the high-pressure treating.

16. The method according to claim 3, further comprising replacing, at least partially, animal protein in the product with vegetable protein, wherein the vegetable protein was subjected to a separate high-pressure treatment.

17. The method according to claim 4, further comprising replacing, at least partially, animal protein in the product with vegetable protein, wherein the vegetable protein was subjected to a separate high-pressure treatment.

18. The method according to claim 4, further comprising adding bacteriophages to the product prior to the high-pressure treating.

19. The method according to claim 4, further comprising adding bacteriophages to the product.

20. The method according to claim 5, further comprising adding bacteriophages to the product.
